(19) United States
(12) Patent Application Publication
(10) Pub. No.: US 2012/0163289 A1
(43) Pub. Date: Jun. 28, 2012

(54) NODE APPARATUS, NODE MANAGEMENT APPARATUS AND METHOD, AND COMMUNICATION SYSTEM BASED ON CONTINUOUS NETWORK CONNECTIVITY-LACKING NETWORK

(75) Inventors: Seung-Hun Oh, Gwangju-si (KR); Seok-Kap Ko, Gwangju-si (KR); Il-Kyun Park, Daejeon-si (KR); Byung-Tak Lee, Suwon-si (KR); Jai-Sang Koh, Gwangju-si (KR)

(73) Assignee: ELECTRONICS AND TELECOMMUNICAIONS RESEARCH INSTITUTE, Daejeon-si (KR)

(21) Appl. No.: 13/211,922

(22) Filed: Aug. 17, 2011

(30) Foreign Application Priority Data
Dec. 23, 2010 (KR) 10-2010-0133833

(51) Int. Cl. H04W 76/02; H04B 7/185

(52) U.S. Cl. 370/316; 370/329

(57) ABSTRACT

A continuous connectivity-lacking network environment-based node apparatus, node management apparatus, communication system, and node management method are provided. The node management apparatus includes a communication unit configured to receive node information from the mobile node through an additional communication network, which is separate from a continuous connectivity-lacking network, and transmit contact information generated by a control unit regarding one or more neighboring nodes of the mobile node to the mobile node via the additional communication network; and the control unit configured to generate the contact information based on the node information received by the communication unit. Accordingly, it is possible for the mobile node to quickly set a communication link and search for any neighboring communicable node.

### CROSS-REFERENCE TO RELATED APPLICATION(S)

This application claims the benefit under 35 U.S.C. §119(a) of Korean Patent Application No. 10-2010-0133833, filed on Dec. 23, 2010, in the Korean Intellectual Property Office, the entire disclosure of which is incorporated herein by reference for all purposes.

### BACKGROUND

1. Field

The following description relates to a communication network service technology, and more particularly, to a continuous network connectivity-lacking network-based communication is service technology.

2. Description of the Related Art

Delay-tolerant networks (DTNs), which are also referred to as disruption-tolerant networks, are networks that lack continuous network connectivity.

In order for a DTN node to communicate in a DTN, a communicable link needs to be set, and neighboring nodes that support the DTN need to be searched for. A routing process may be performed to determine whether to transmit bundles, which are units of data transmission defined in DTN technology, to the neighboring nodes.

The DTN technology is based on the Bundle Protocol Specification also known as RFC 5050. The Bundle Protocol Specification defines the basic processes of transmitting and receiving bundle data. However, a technique of searching for DTN-supporting neighboring nodes is yet to be standardized and a draft standard for searching for DTN-supporting neighboring nodes has been released and is under review by the Delay-Tolerant Networking Research Group (DTNRG). According to this draft standard, searching for DTN-supporting neighboring nodes is characterized by periodically broadcasting or multicasting information indicating the existence of DTN nodes and service information corresponding to services supported by the DTN nodes, and the amount of time that it takes to search for any neighboring node may be determined by the interval of broadcasting or multicasting such information.

The shorter the interval of broadcasting or multicasting information for detecting any neighboring node, the larger the amount of traffic applied to a network becomes, and the larger the load of the network becomes. To search for a neighboring node several IP hops (e.g., several nodes or routers) away, an IP multicasting or unicasting method needs to be used. However, the IP multicasting method is only supported by a few special networks, and is thus difficult to be used. The unicasting method is based on the assumption that information corresponding to a neighboring node is already known, and may not be suitable for use in detecting a new node or a neighboring node whose information is not known.

### SUMMARY

The following description relates to a technique to allow a node to quickly establish a communication link in a continuous network connectivity-lacking network environment and search for any neighboring node to communicate with.

In one general aspect, there is provided a node management apparatus to manage a mobile node that lacks continuous connectivity to other nodes, the node management apparatus including a communication unit configured to receive node information from the mobile node through an additional communication network, which is separate from a continuous connectivity-lacking network, and transmit contact information generated by a control unit regarding one or more neighboring nodes of the mobile node to the mobile node via the additional communication network; and the control unit configured to generate the contact information based on the node information received by the communication unit.

In another general aspect, there is provided a mobile node apparatus that lacks continuous connectivity to other nodes, the mobile node apparatus including a node communication unit configured to transmit node information corresponding to the mobile node apparatus to a node management apparatus via an additional communication network, which is separate from a continuous connectivity-lacking network and receive contact information corresponding to one or more neighboring nodes of the mobile node apparatus from the node management apparatus; and a node control unit configured to search for any communicable neighboring node based on the contact information and set a communication link.

In another general aspect, there is provided a communication system based on a continuous connectivity-lacking network, the communication system including a node management apparatus configured to receive node information from a mobile node apparatus via an additional communication network, which is separate from the continuous connectivity-lacking network, generate contact information corresponding to one or more neighboring nodes that the mobile node apparatus can communicate with based on the received node information, and transmit the generated contact information to the mobile node apparatus via the additional communication network; and the mobile node apparatus configured to search for the neighboring nodes based on the contact information transmitted by the node management apparatus and set a communication link.

In another general aspect, there is provided a method of managing a mobile node that lacks continuous connectivity to other nodes, the method including receiving node information from the mobile node via an additional communication network, which is separate from a continuous connectivity-lacking network; and generating contact information corresponding to one or more neighboring nodes that the mobile node can communicate with based on the received node information and transmitting the generated contact information to the mobile node via the additional communication network.

Other features and aspects may be apparent from the following detailed description, the drawings, and the claims.

### BRIEF DESCRIPTION OF THE DRAWINGS

FIG. 1 is a diagram illustrating an example of a high-speed network access process performed by a continuous network connectivity-lacking network environment-based communication system.

FIG. 2 is a diagram illustrating an example of the structures of a node management apparatus and a delay-tolerant network (DTN) node.

FIG. 3 is a diagram illustrating an example of a DTN access process in an environment in which an infrastructure communication access node exists.

FIG. 4 is a diagram illustrating an example of a DTN access process in an environment in which a neighboring fixed node exists.

FIG. 5 is a diagram illustrating an example of a DTN access process in an environment in which a neighboring mobile node exists.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

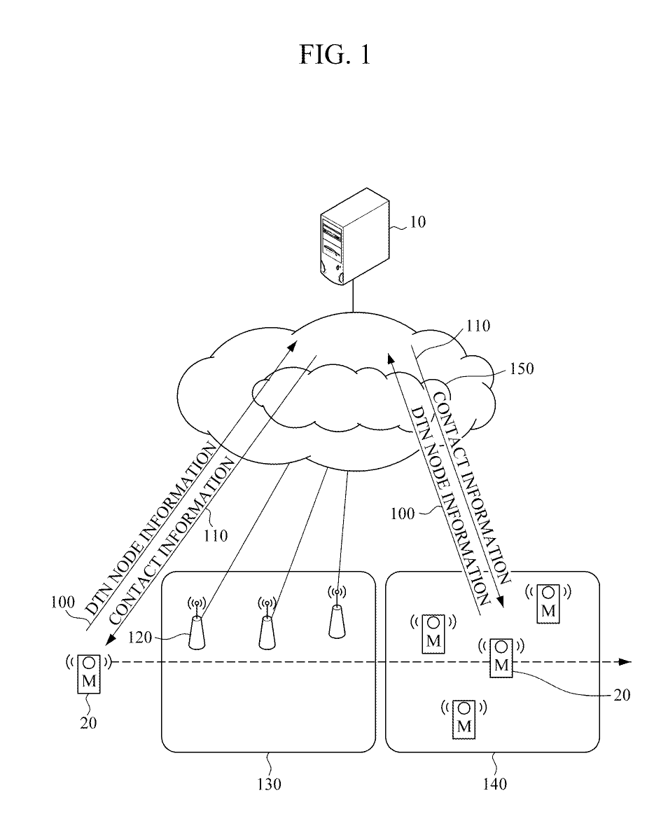

FIG. 1 illustrates an example of a high-speed network access process performed by a continuous network connectivity-lacking network environment-based communication system.

Various aspects are directed toward a continuous network connectivity-lacking network environment-based communication service technique. For convenience, a network that lacks continuous network connectivity is referred to as a delay- or disruption-tolerant network (DTN).

Various aspects are also directed toward a technique to allow nodes in a DTN environment to access a DTN at high speed and thus to stably communicate data with each other. Referring to FIG. 1, node management apparatus 10 may manage a DTN node 20 so that the DTN node 20 can quickly establish a communication link and can search for any neighboring node to communicate with. In response to the DTN node 20 providing DTN node information to the node management apparatus 10, the node management apparatus 10 may provide contact information for the DTN node 20 to quickly communicate with any neighboring node.

The node management apparatus 10 and the DTN node 20 may use an additional communication network 150, which is separate from a DTN, for transmitting DTN node information and contact information. For example, the node management apparatus 10 may receive DTN node information from the DTN node 20 via the additional communication network 150. The node management apparatus 10 may generate contact information corresponding to one or more neighboring node of the DTN node 20 based on DTN node information received via the additional communication network 150, and may transmit the generated contact information to the DTN node 20 via the additional communication network 150.

The additional communication network 150 may be a network for transmitting a small amount of control data. Examples of the additional communication network 150 include nearly all types of wireless networks that provide the DTN node 20 with a stable network connection. For example, the additional communication network 150 may be a second-generation (2G) or third-generation (3G) mobile communication network, a WiBro/WiMax network, or a satellite communication network, and the DTN node 20 that are connected to one another via wires may be internet networks. The node management apparatus 10 and the DTN node 20 may communicate with each other more quickly and stably when using both the DTN and the additional communication network 150 than when using the DTN alone.

The node management apparatus 10 manages the DTN node 20. The node management apparatus 10 may manage node identifier (ID) information, node location information, communication region information, communication region varied location coordinate information, and moving path information (e.g., bus route information) corresponding to the DTN node 20 and communicable neighboring node information corresponding to any neighboring node that the DTN node 20 can communicate with. The node ID information may include the IP address of the DTN node 20 and the URL-type endpoint identifier (EID) of the DTN node 20. The node location information may include the current location of the DTN node 20 and moving vector information corresponding to the DTN node 20. The communication region information may include information indicating whether the DTN node 20 resides in an infrastructure mode communication region 130 or an ad-hoc mode communication region 140.

The DTN node 20 may transmit DTN node information to the node management apparatus 10. The DTN node information may include node ID information, node location information, communication interface information, and moving path information corresponding to the DTN node 20. The node ID Information may include the IP address and the EID of the DTN node 20. The communication interface information may include communication interface type information, communication interface ID information, and communication state information corresponding to the DTN node 20.

The node management apparatus 10 may transmit contact information to the DTN node 20. For example, the node management apparatus 10 may transmit contact information to the DTN node 20 as a response to the DTN node information received from the DTN node 20. As another example, the node management apparatus 10 may transmit contact information unilaterally to one or more nodes that are affected by other DTN node information.

Contact information may include neighboring node information, communication region information, and information for setting a communication link. The neighboring node information may include a list of neighboring nodes, the IDs of the neighboring nodes, and location information and communication interface information corresponding to the neighboring nodes. The communication region information may include information corresponding to the infrastructure mode communication region 130 or the ad-hoc mode communication region 140.

In the infrastructure mode communication region 130, the DTN node 20 may access typical infrastructure communication access nodes 120 to establish a communication link. In the infrastructure mode communication region 130, nodes may communicate with each other using a typical communication method. For example, in a wireless local area network (WLAN) environment, nodes may associate and communicate with an access point (AP) in an infrastructure mode.

The ad-hoc mode communication region 140, the DTN node 20 may access DTN-supporting nodes, instead of the typical infrastructure communication access nodes 120, to establish a communication link. To communicate with DTN-supporting nodes, the DTN node 20 may need to set a direct communication connection to the DTN-supporting nodes. For example, in a WLAN environment, the DTN node 20 may communicate with DTN-supporting nodes in an ad-hoc mode. The ad-hoc mode is a network mode in which nodes communicate with each other wirelessly without a requirement of an AP.

The node management apparatus 10 may manage the infrastructure mode communication region 130 and the ad-hoc mode communication region 140 separately in order for the DTN node 20 to properly prepare for each of the infrastructure mode and the ad-hoc mode corresponding to the infrastructure mode communication region 130 and the ad-hoc mode communication region 140, respectively.

For example, in case that the DTN node 20 enters the infrastructure mode communication region 130 from the ad-hoc mode communication region 140, the node management apparatus 10 may provide the DTN node 20 in advance with communication region information. Accordingly, the DTN node 20 can switch its communication mode to the infrastructure mode before entering the infrastructure mode communication region 130. The node management apparatus 10 may set most of the communication region as the ad-hoc mode communication region 140 so that the DTN node 20 can meet with other DTN nodes. The node management apparatus 10 may set a communication region in which typical communication infrastructure is installed as the infrastructure mode communication region 130 and may allow the DTN node 20 to be switched to the infrastructure mode upon entering the infrastructure mode communication region 130.

A neighboring node list, which is included in contact information, may be information corresponding to any neighboring node that the DTN node 20 can communicate with. The neighboring nodes may include not only DTN nodes that support a DTN function in a wireless environment and but also DTN nodes that support a DTN function in a wired environment (e.g., the internet). Information for setting a communication link, which is also included in contact information, may include data necessary for the DTN node 20 to access typical communication infrastructure quickly. For example, the information for setting a communication link may include the service set identifier (SSID) of an AP in a WLAN. In this example, by providing the SSID of the AP to the DTN node 20 in advance, it is possible for the DTN node 20 to quickly associate with the AP by skipping an AP scan process.

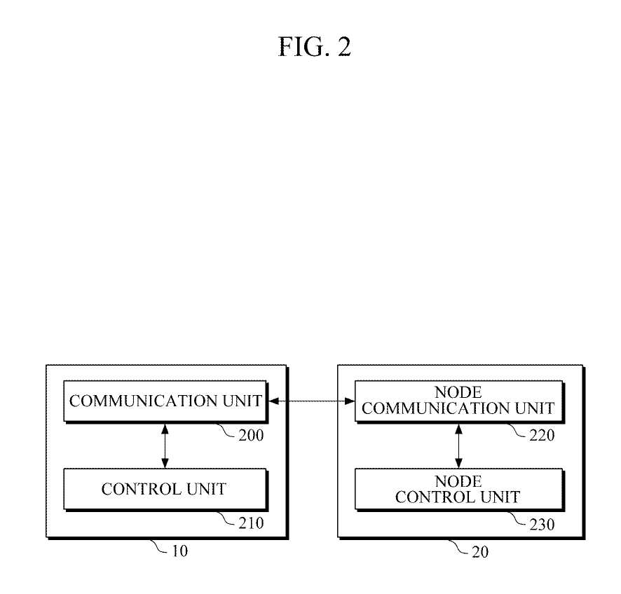

FIG. 2 illustrates examples of the structures of the node management apparatus 10 and the DTN node 20.

Referring to FIG. 2, the node management apparatus 10 may include a communication unit 200 and a control unit 210. The DTN node 20 may include a node communication unit 220 and a node control unit 230.

The communication unit 200 of the node management apparatus 10 may receive DTN node information from the DTN node 20 via an additional communication network, which is separate from a DTN. The communication unit 200 may transmit contact information corresponding to one or more neighboring nodes of the DTN node 20, which is generated by the control unit 210 of the node management apparatus 10, to the DTN node 20 via the additional communication network. The control unit 210 may generate the contact information based on node information received from the neighboring nodes via the communication unit 200.

For example, the communication unit 200 may receive DTN node information from the DTN node 20 via an additional communication network that is accessed for the first time by the DTN node 20. As another example, the communication unit 200 may receive DTN node information from the DTN node 20 via an additional communication network in response to the DTN node 20 entering a communication region designated by the node management apparatus 10. For a proper management of information, the node management apparatus 10 may receive DTN node information at regular intervals of time. The frequency and method of receiving DTN node information may be set by a manager.

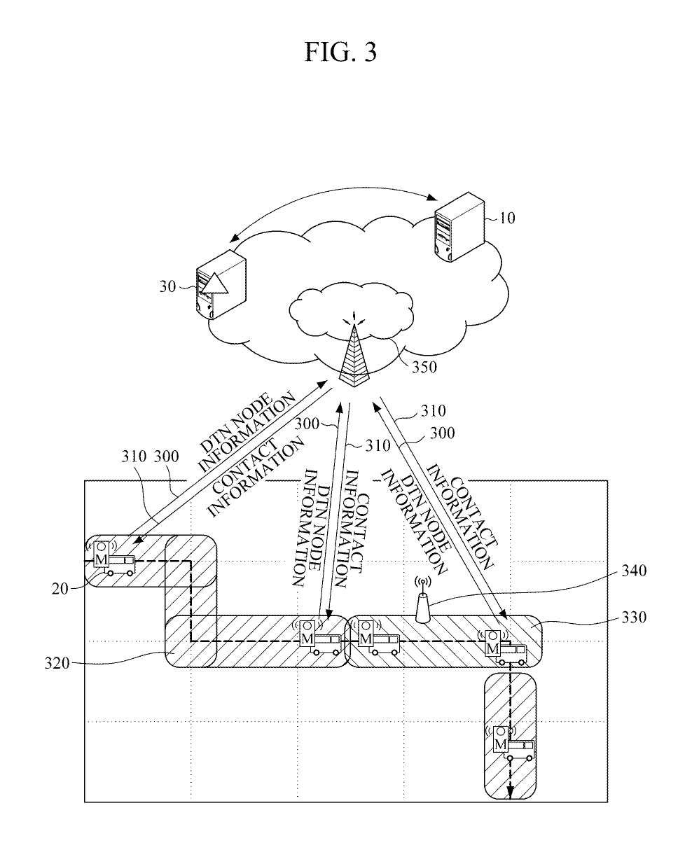

For example, in response to the DTN node 20 arriving at the border between a DTN-supporting communication region and a non-DTN-supporting communication region, the communication unit 200 may receive DTN node information from the DTN node 20 via an additional communication network, and may transmit contact information including a communication region to be entered by the DTN node 20 to the DTN node 20. This example is further described with reference to FIG. 3.

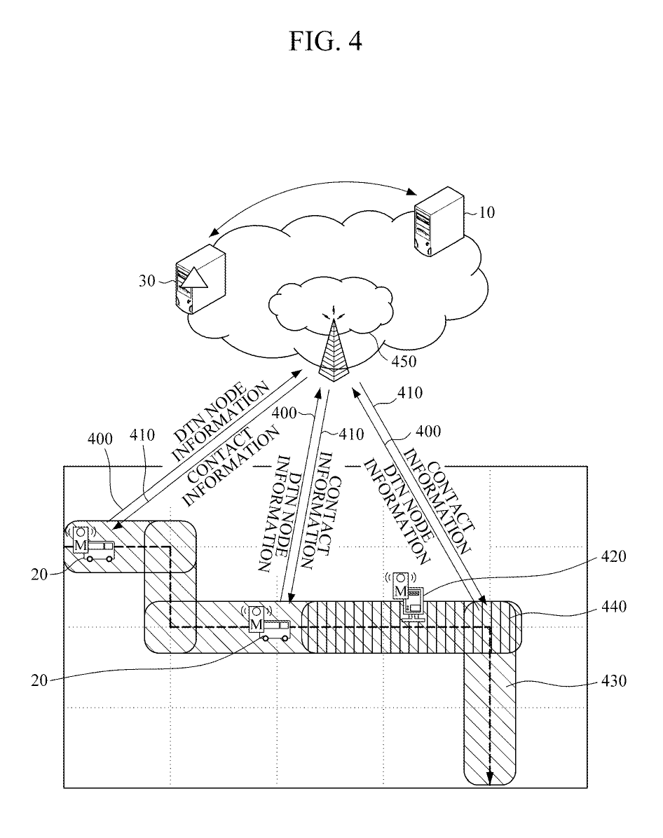

As another example, in response to the DTN node 20 arriving in the vicinity of a neighboring DTN-supporting fixed node, the communication unit 200 may receive DTN node information from the DTN node 20 via an additional communication network, and may transmit updated contact information for the DTN node 20 to communicate with the neighboring fixed node to the DTN node 20. This example is further described with reference to FIG. 4.

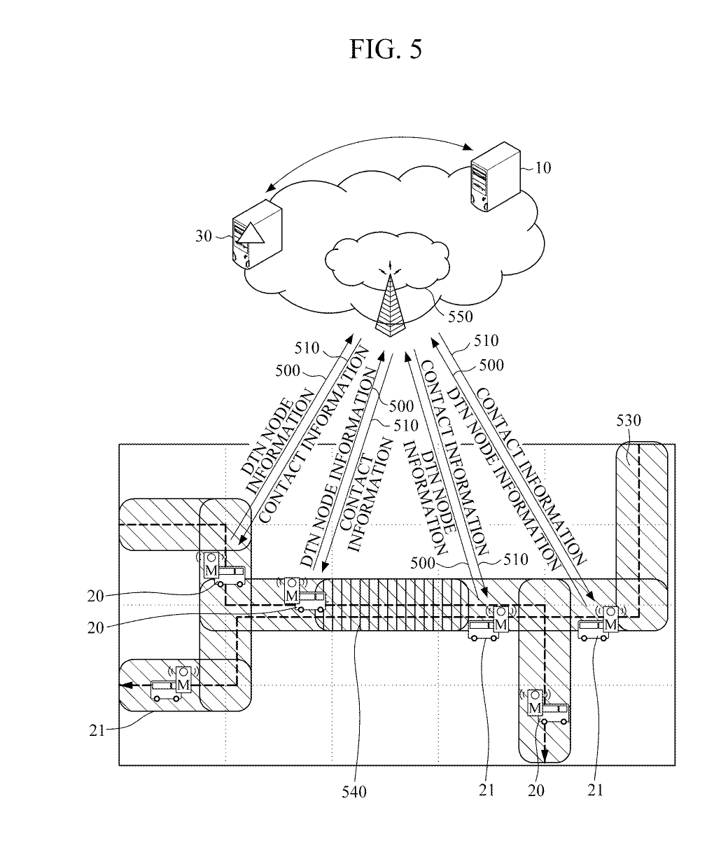

As still another example, in response to the DTN node 20 arriving in the vicinity of a neighboring mobile node that supports a continuous network connectivity-lacking network, the communication unit 200 may receive DTN node information from the DTN node 20 via an additional communication network, and may transmit contact information including information on a communicable region calculated by the control unit 210 to the DTN node 20 and the neighboring mobile node. In this example, the communicable region may be a region in which the DTN node 20 and the neighboring mobile node can communicate with each other. This example is further described with reference to FIG. 5.

For example, the control unit 210 may calculate the moving speed of the DTN node 20 based on the DTN node information received from the DTN node 20. In this example, the communication unit 200 may transmit contact information including the result of the calculation performed by the control unit 210 to the DTN node 20 via an additional communication network.

The node communication unit 220 of the DTN node 20 may transmit DTN node information corresponding to the DTN node 20 to the node management apparatus 10 via an additional communication network, and may receive contact information corresponding to any neighboring node of the DTN node 20 from the node management apparatus 10. The node control unit 230 of the node management apparatus 10 may search for any neighboring node that the DTN node 20 can communicate with based on the contact information received by the node communication unit 220, and may set a communication link to the discovered neighboring node.

FIG. 3 illustrates an example of a DTN access process in an environment in which an infrastructure communication access node exists, and particularly, a scenario regarding how a mobile DTN node 20 transmits data to a DTN service server 30 while moving along a fixed path in an environment where an infrastructure communication access node 330 exists on the fixed path.

Referring to FIG. 3, a dotted arrow indicates the path of the movement of the mobile DTN node 20, indicates an ad-hoc mode communication region 320, and indicates an infrastructure mode communication region 330.

The mobile DTN node 20 may register its ID, location information, and network communication interface information in the node management apparatus 10 by transmitting DTN node information to the node management apparatus 10. The node management apparatus 10 may acquire moving path information corresponding to the mobile DTN node 20 using the ID of the mobile DTN node 20 or may be directly provided with the moving path information by the mobile DTN node 20.

The node management apparatus 10 may transmit contact information to the DTN node as a response to the DTN node information. The mobile DTN node 20 may set a communication mode based on the contact information, and may acquire neighboring node information corresponding to any communicable neighboring node. Referring to FIG. 3, since there are no neighboring DTN nodes on the move, the mobile DTN node 20 may acquire information corresponding to the DTN service server 30 that is connected to the mobile DTN node 20 via wires.

The contact information may include communication region information and information for setting a communication link, for example, location information corresponding to a WLAN AP and the SSID and MAC address of the WLAN AP. The contact information may also include information corresponding to a communication region for which an event for transmitting the DTN node information is to be triggered, for example, the coordinates of a location in the ad-hoc mode communication region 320 near the infrastructure mode communication region 330.

Referring to FIG. 3, in response to the mobile DTN node 20 approaching near the infrastructure mode communication region 330 while moving across the ad-hoc mode communication region 320, the mobile DTN node 20 may be automatically triggered to transmit the DTN node information to the node management apparatus 10 and may receive updated contact information from the node management apparatus 10 in response. The mobile DTN node 20 may switch its communication mode from the ad-hoc mode to the infrastructure mode based on the updated contact information, may associate with a WLAN AP using an SSID and a MAC address included in the updated contact information, may set a communication link, and may quickly transmit bundle data to the DTN service server 30.

FIG. 4 illustrates an example of a DTN access process in an environment in which a neighboring fixed node exists, and particularly, a scenario regarding how a mobile DTN node 20 transmits data to a DTN service server 30 while moving along a fixed path in an environment where a fixed DTN node 420 exists on the fixed path.

Referring to FIG. 4, a dotted arrow indicates the path of the movement of the mobile DTN node 20, indicates an ad-hoc mode communication region 430, and indicates a DTN communication region 440. Assume that the mobile DTN node 20 moves along a fixed path (e.g., a bus route), and that the fixed DTN node 420 exists on the fixed path.

The node management apparatus 10 may identify the location of the fixed DTN node 420 and radio propagation range information corresponding to the fixed DTN node 420 based on DTN node information provided by the fixed DTN node 420. For example, the mobile DTN node 20 may identify node information corresponding to the fixed DTN node 420 based on initial contact information provided by the node management apparatus 10 while moving along a fixed path. In this example, the mobile DTN node 20 may identify the fixed DTN node 420 as a node on its moving path, but not as a communicable neighboring node. The DTN node 420 may be triggered, based on the radio propagation range information included in the initial contact information, to transmit DTN node information to the node management apparatus 10, and may receive updated contact information from the node management apparatus 10 in response.

The node management apparatus 10 may determine whether the mobile DTN node 20 is approaching near the fixed DTN node 420, and may transmit contact information including the results of the determination to the fixed DTN node 420.

Since the mobile DTN node 20 and the fixed DTN node 420 are both provided with contact information by the node management apparatus 10, the mobile DTN node 20 and the fixed DTN node 420 can quickly detect each other, set a communication link, and exchange bundle data with each other.

FIG. 5 illustrates an example of a DTN access process in an environment in which a neighboring mobile node exists, and particularly, a scenario regarding how a mobile DTN node 20 transmits data to a DTN service server 30 while moving along a fixed path in an environment where another mobile DTN node 21 exists on the fixed path.

Referring to FIG. 5, dotted arrows the paths of the movement of the mobile DTN nodes 20 and 21, indicates an ad-hoc mode communication region 530, and indicates a DTN communication region 540.

The node management apparatus 10 may identify, based on DTN node provided by the mobile DTN nodes 20 and 21, that there is an overlapping area of the paths of the movement of the mobile DTN nodes 20 and 21. The node management apparatus 10 may calculate the moving speeds of the mobile DTN nodes 20 and 21 and may calculate a communicable region in which the mobile DTN nodes 20 and 21 can communicate with each other based on the calculated moving speeds of the mobile DTN nodes 20 and 21. The node management apparatus 10 may transmit contact information including the calculated moving speeds of the mobile DTN nodes 20 and 21 and the calculated communicable region to the mobile DTN nodes 20 and 21. In response to the mobile DTN nodes 20 and 21 arriving in the calculated communicable region, the mobile DTN nodes 20 and 21 may quickly detect each other, set a communication link, and may exchange bundle data with each other.

As described above, in a network connectivity-lacking network environment, a DTN management apparatus manages information corresponding to a DTN node through an additional control plane and transmits contact information corresponding to one or more neighboring nodes of the DTN node to the DTN node through the additional control plane, thereby allowing the DTN node to quickly search for the neighboring nodes, to set a communication link, and to stably transmit data to the neighboring nodes. In addition, since neighboring node information received by the DTN node through the additional control plane includes layer 3 information, the DTN node can effectively search for even nodes that are several hops (e.g., several IP nodes or routers) away from the DTN node.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A node management apparatus to manage a mobile node that lacks continuous connectivity to other nodes, the node management apparatus comprising:
a communication unit configured to receive node information from the mobile node through an additional communication network, which is separate from a continuous connectivity-lacking network, and transmit contact information generated by a control unit regarding one or more neighboring nodes of the mobile node to the mobile node via the additional communication network; and
the control unit configured to generate the contact information based on the node information received by the communication unit.

2. The node management apparatus of claim 1, wherein the continuous connectivity-lacking network comprises a delay-tolerant network (DTN), and the additional communication network comprises at least one of a mobile communication network, a wired or wireless communication network, and a satellite communication network.

3. The node management apparatus of claim 1, wherein the node information comprises at least one of an identifier (ID) of the mobile node and location information, communication interface information, and moving path information corresponding to the mobile node.

4. The node management apparatus of claim 1, wherein the contact information comprises at least one of neighboring node information that includes a list of the neighboring nodes, IDs of the neighboring nodes, and location information and communication interface information corresponding to the neighboring nodes, communication region information, and information for setting a communication link.

5. The node management apparatus of claim 1, wherein the communication unit is configured to, in response to the mobile node arriving at a border between an ad-hoc network communication region and an infrastructure communication region, receive the node information from the mobile node and transmit contact information including a communication region to be entered by the mobile node to the mobile node via the additional communication network.

6. The node management apparatus of claim 1, wherein the communication unit is configured to, in response to the mobile node arriving in a vicinity of a neighboring fixed node that supports the continuous connectivity-lacking network, receive the node information from the mobile node and transmit to the mobile node updated contact information for the mobile node to communicate with the neighboring fixed node based on the received node information and node information corresponding to the neighboring fixed node via the additional communication network.

7. The node management apparatus of claim 1, wherein the communication unit is configured to, in response to the mobile node arriving in a vicinity of a neighboring mobile node that supports the continuous connectivity-lacking network, receive the node information from the mobile node and transmit contact information including communicable region information calculated by the control unit to the mobile node via the additional communication network and the neighboring mobile node, and the control unit is configured to calculate a communication region in which the mobile node and the neighboring mobile node can communicate with each other.

8. The node management apparatus of claim 1, wherein the control unit is configured to calculate a moving speed of the mobile node based on the node information, and the communication unit is configured to transmit contact information including the calculated moving speed of the mobile node to the mobile node via the additional communication network.

9. A mobile node apparatus that lacks continuous connectivity to other nodes, the mobile node apparatus comprising:
a node communication unit configured to transmit node information corresponding to the mobile node apparatus to a node management apparatus via an additional communication network, which is separate from a continuous connectivity-lacking network and receive contact information corresponding to one or more neighboring nodes of the mobile node apparatus from the node management apparatus; and
a node control unit configured to search for any communicable neighboring node based on the contact information and set a communication link.

10. The mobile node apparatus of claim 9, wherein the node communication unit is configured to, in response to the mobile node apparatus arriving at a border between an ad-hoc network communication region and an infrastructure communication region, transmit the node information to the node management apparatus via the additional communication network and receive contact information including a communication region to be entered by the mobile node apparatus from the node management apparatus via the additional communication network, and the node control unit is configured to switch from one communication network to another communication network based on the contact information including the communication region to be entered by the mobile node apparatus.

11. The mobile node apparatus of claim 9, wherein the node communication unit is configured to, in response to the mobile node apparatus arriving in a vicinity of a neighboring node that supports the continuous connectivity-lacking network, transmit the node information to the node management apparatus via the additional communication network and receive updated contact information from the node management apparatus via the additional communication network, and the node control unit is configured to search for the neighboring node based on the updated contact information and set a communication link.

12. The mobile node apparatus of claim 9, wherein the node communication unit is configured to transmit the node information to the node management apparatus via an additional communication network that is accessed for a first time by the mobile node apparatus.

13. The mobile node apparatus of claim 9, wherein the node communication unit is configured to, in response to the mobile node apparatus arriving in a communication region designated by the node management apparatus, transmit the node information to the node management apparatus via the additional communication network.

14. A communication system based on a continuous connectivity-lacking network, the communication system comprising:
a node management apparatus configured to receive node information from a mobile node apparatus via an additional communication network, which is separate from the continuous connectivity-lacking network, generate contact information corresponding to one or more neighboring nodes that the mobile node apparatus can communicate with based on the received node information, and transmit the generated contact information to the mobile node apparatus via the additional communication network; and
the mobile node apparatus configured to search for the neighboring nodes based on the contact information transmitted by the node management apparatus and set a communication link.

15. A method of managing a mobile node that lacks continuous connectivity to other nodes, the method comprising:
receiving node information from the mobile node via an additional communication network, which is separate from a continuous connectivity-lacking network; and
generating contact information corresponding to one or more neighboring nodes that the mobile node can communicate with based on the received node information and transmitting the generated contact information to the mobile node via the additional communication network.

16. The method of claim 15, wherein the receiving the node information comprises, in response to the mobile node arriving at a border between an ad-hoc network communication region and an infrastructure communication region, receiving the node information from the mobile node via the additional communication network and the generating the contact information and transmitting the generated contact information, comprises generating contact information including a communication region to be entered by the mobile node based on the received node information and transmitting the generated contact information to the mobile node.

17. The method of claim 15, wherein the receiving the node information comprises, in response to the mobile node arriving in a vicinity of a neighboring fixed node that supports the continuous connectivity-lacking network, receiving the node information from the mobile node via the additional communication network and the generating the contact information and transmitting the generated contact information, comprises generating updated contact information for the mobile node to communicate with the neighboring fixed node based on the received node information and node information corresponding to the neighboring fixed node and transmitting the generated updated contact information to the mobile node.

18. The method of claim 15, wherein the receiving the node information comprises, in response to the mobile node arriving in a vicinity of a neighboring mobile node that supports the continuous connectivity-lacking network, receiving the node information from the mobile node via the additional communication network and the generating the contact information and transmitting the generated contact information, comprises generating contact information including communicable region information calculated by the control unit based on the received node information and transmitting the generated contact information to the mobile node.
